(19) United States
(12) Patent Application Publication
(10) Pub. No.: US 2009/0147075 A1
(43) Pub. Date: Jun. 11, 2009

(54) METHOD FOR PRODUCING DIFFERENTIAL OUTPUTS FROM A SINGLE VIDEO SOURCE

(76) Inventor: James Plant, Victoria (CA)

Correspondence Address: DAVIS & BUJOLD, P.L.L.C., 112 PLEASANT STREET, CONCORD, NH, 03301, US

(21) Appl. No.: 12/330,019

(22) Filed: Dec. 8, 2008

Related U.S. Application Data
(60) Provisional application No. 60/992,739, filed on Dec. 6, 2007.

(51) Int. Cl. H04N 9/47

(52) U.S. Cl. 348/54; 348/E09.033

(57) ABSTRACT

A method for producing differential outputs from a single video source. A first step involves providing a single video source with two or more sequentially intermeshed video streams. A second step involves isolating through on and off temporal synchronization at least one of the sequentially intermeshed video streams.

### FIELD

The present intention relates to a method and system for the creation of differential outputs from a single video source. The differential outputs can be viewed serially or concurrently on a viewing screen.

### BACKGROUND

Many video games, and videogame systems, allow for more than one player to simultaneously be involved in playing the games. While the graphical representation of some games (such as chess, board games and card games) involving multiple players can be presented from a single Point of View (POV) on a single video screen, more complex multi player games require separate POVs for each player. This can be accomplished by (1) each player taking turns while their unique POV is being displayed sequentially, or (2) utilising a “split screen” approach where the screen area of a single video monitor is divided into two or more regions, each region projecting the POV of one player. While this does allow for simultaneous gaming, the overall visual experience for each player is significantly diminished by the reduction of the individual image size, as well as the distraction of having ongoing video being present in an adjacent area(s) of the monitor that is unrelated to their individual gaming experience.

An unrelated technology, which has been developed to enhanced the game playing and video experiences of individuals, is that of 3-D video presentation. One of the most common forms of 3-D viewing technology utilises the fact that (1) each eye of the viewer perceives a slightly different perspective of a common three-dimensional scene, and (2) human visual perception operates in such a way that a rapidly presented a series of individual pictures presented at a frequency of greater than 14 frames per second are perceived as being a continuous or single image. Utilising these facts, viewing glasses have been created that sequentially present alternate (laterally displaced) views of a common scene to the left and the right eye by rapidly altering the transmissive properties of the left and right lens in synchrony with the alternating presentation on the video screen of images for the left and then the right eye respectively (see Beljet, U.S. Pat. No. 5,002,387; MacDonald, U.S. Pat. No. 5,083,851; Kilian, U.S. Pat. No. 5,245,319). As a result of human perception, these independently viewed alternate visual perspectives, which are presented sequentially to the left and right eyes, are fused to result in the perception of a single three-dimensional scene.

Berman (U.S. Pat. No. 4,879,603) proposed a system whereby rapidly alternating visual images, passing through an intervening active circular polarizing assembly, could be simultaneously viewed by two users (one wearing glasses containing left circularly polarised lenses and the other viewer wearing glasses containing right circularly polarised lenses). By alternating the handedness of the circularly polarised video output of successive frames, and with each viewer wearing glasses having left or right circularly polarized lenses, each viewer would only see alternating frames of the video output which would fuse to create the perceptual impression of continuous POV. In this way, two independent images could be “simultaneously” presented to two individuals using a single display system.

### SUMMARY

There is provided a method for producing differential outputs from a single video source. A first step involves providing a single video source with two or more sequentially intermeshed video streams. A second step involves isolating through on and off temporal synchronization at least one of the sequentially intermeshed video streams.

As will hereinafter be further described, viewing can be shared viewing of a single video stream on a common display or viewing can be concurrent independent viewing of different video streams on a common display system.

The present invention was originally developed for the video game market. The intent was to allow each party to concurrently view the same viewing screen, but see different outputs. It has subsequently been determined that there are a number of other practical applications for this method, as will hereinafter be further described.

One application is in pay for view movies. More than one pay for view movie can be sent to a household in a sequentially intermeshed video stream. The number of pay for view movies that can be sent will depend upon the number of times a screen refreshes itself every second. It is critical that the screen be refreshed sufficiently frequently that it is imperceptible to the human eye. This threshold is crossed when a screen refreshes itself approximately 14-20 times per second. It is believed that two movies can be sequentially intermeshed where the screen is refreshed 60 times a second and as many as four movie serially intermeshed where the screen is refreshed 120 times a second. A decoder can then be provided to isolate a selected pay for view movie and black out or substitute the remaining non-selected intermeshed movie frames. The decoder will have a viewing mode that allows a video stream to be viewed and a blackout mode that obscures a video stream. The decoder is synchronized to be in the viewing mode with the selected one and in the blackout mode with all other of the two more more sequentially intermeshed video streams.

While the above explains how differential outputs ( two to f our movies), can be received by a household from a single video source, the same principle can be used within the household to allow viewers to concurrently view the differential outputs (different movies). For example, if a husband wished to watch an action movie and a wife wished to watch a romantic movie, both movies would be concurrently displayed on the viewing screen. The “decoder” in such a case would have to be on the person in the form of viewing glasses. The principle would be the same. Each pair of viewing glasses would have a viewing mode that allows a video stream to be viewed and a blackout mode that obscures a video stream. The viewing glassed worn by the husband would be synchronized to be in the viewing mode with the action movie and in the blackout mode with the romantic movie. Conversely, the viewing glassed worn by the wife would be synchronized to be in the viewing mode with the romantic movie and in the blackout mode with the action movie. These differential viewing glasses were the form that the original embodiment took, which was intended for the video gaming market.

Timing is critical to isolate and extract a desired image from a video source that consists of several sequentially intermeshed video screens. The teaching is transferable to various viewing screen technologies including projectors that project images one walls.

It will be apparent to one skilled in the art how two or more individual video sequences can be sequentially intermeshed in such a way as to (1) maintain the sequential and temporal integrity of the individual video streams, and (2) allow for the selective isolation and display of any of the one or more intermeshed video sequences. In its simplest form the individual video streams can be time locked using their embedded sync pulses, momentarily held in video buffers, and the final compound video signal created by reading the individual frames out of those separate video buffers in the sequential manner.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1. is a schematic illustration of a method for the creation of an alternating video stream from two independent video series.

FIG. 2. is a schematic illustration of system components and methods for creating differential outputs from a single video source, shown in a state with exclusive transmission of the first frame of the alternating video stream through the top pair of glasses (16).

FIG. 3. is a schematic illustration of system components and methods for creating differential outputs from a single video source, shown in a state with exclusive transmission of the second frame of the alternating video stream through the bottom pair of glasses (20).

FIG. 4. is a schematic illustration of a decoding method and device to isolate and display a selective series of video frames from a compound video signal comprising of two or more sequentially intermeshed video streams. In this case the first frame of the second embedded video stream has been selected and displayed.

FIG. 5. is a schematic illustration of a decoding method and device to isolate and display a selective series of video frames from a compound video signal comprising of two or more sequentially intermeshed video streams. In this case the second frame of the first embedded video stream has been blocked from being displayed.

FIG. 6. is a schematic illustration of a decoding method and device to isolate and display a selective series of video frames from a compound video signal comprising of two or more sequentially intermeshed video streams. In this case the second frame of the second embedded video stream has been selected and displayed.

FIG. 7. is a schematic illustration of a decoding method which isolates a selective series of video frames from a compound video signal comprising of two or more sequentially intermeshed video streams, creating a single video signal which maintains the display rate's temporal integrity. In this case the second embedded video stream has been selected.

FIG. 8. is a schematic illustration of a decoding method which isolates a selective series of video frames from a compound video signal comprising of two or more sequentially intermeshed video streams, creating a single video signal which maintains the display rate's temporal integrity. In this case the first embedded video stream has been selected.

FIG. 9, labeled as PRIOR ART, is a schematic representation of prior art that utilized circularly polarized outputs from a video source to create independent outputs from a single monitor.

### DETAILED DESCRIPTION

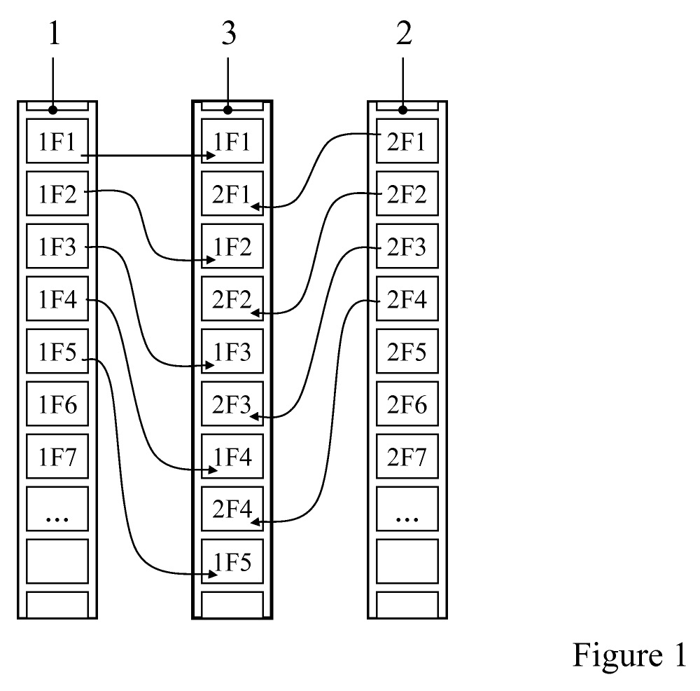

A Method for Producing Differential Outputs from a Single Video Source, will now be described with reference to FIGS. 1 through 9.

FIG. 1 is a graphical representation of the method used to combine two independent streams of video input (items 1 and 2) into a third compound video sequence (item 3), such that the final merged video sequence is comprised of alternating frames from the first (frames 1F1-1F7) and second (frames 2F1-2F7) video sequences. To maintain temporal consistency between the original and compounded video sequences during playback, the merged video series should be played back at two times the presentation speed of the original video sequences. The use of the term “frames” and the representation of a series of frames as a strip of movie film in the accompanying illustration is not meant to imply a physical object, rather it is to illustrate how two individual time series of video or image data can be regrouped to form a compound or merged signal which can be utilised to create concurrent differential output from a single TV or video monitor.

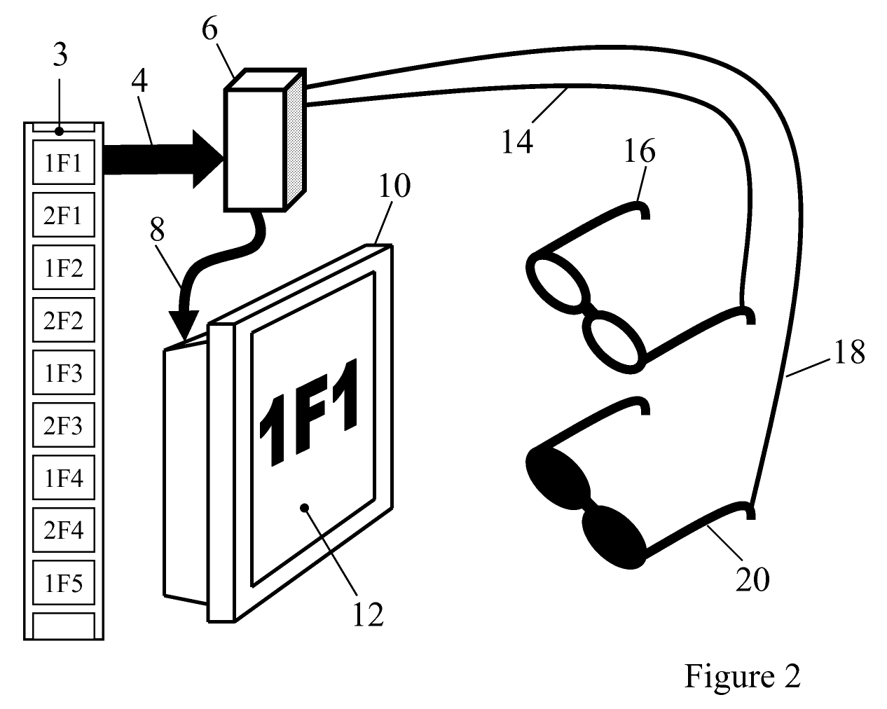

Referring to FIG. 2, a system and method for the production of concurrent differential output from a single video source is shown. The first frame (1F1) of a compound video series (item 3) is imported into a video processing unit (item 6). This video processing unit has three separate output lines (items 8, 14 and 18). The first output (item 8) is the composite video series output which is sent (frame by frame) as an input to the video monitor (item 10). In this illustration, the first frame of the compound video signal (frame 1F1, item 3) is passed to the video processing unit (item 6) which then is displayed (item 12) on the video monitor (item 10). At the same time, the video processing unit (item 6) sends a sync signal (graphically represented by line 18) to block transmission through the lenses of a pair of optically switchable glasses (item 20). As a result, only the observer wearing the other pair of optically switchable glasses (item 16) will see the video frame (item 12) being displayed on the monitor (item 10).

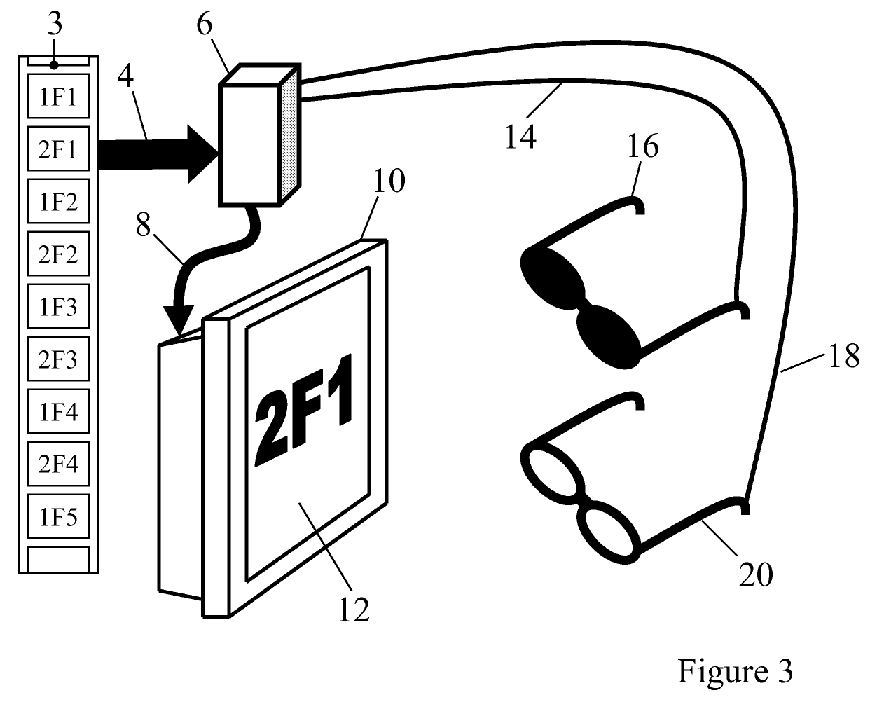

FIG. 3 illustrates the state of the system during the presentation of the second frame (2F1) of the compound video series (item 3). As before, the second frame of the compound video time series (2F1) is transferred to the video processing unit (item 6), giving rise to two simultaneous outputs. One output (item 8) transfers the video frame to the video monitor (item 10) to be displayed (item 12). At the same time a sync signal (item 14) is sent to a optically switchable glasses pair (item 16) which blocks transmission of light through its lenses. As a result, video frame 2F1 (item 12) can only be seen by the observer wearing the second pair of optically switchable glasses (item 20). By rapidly repeating the states represented in FIGS. 2 and 3, the observers wearing the optically switchable glasses (items 16 and 20) will perceptually experience two distinct video presentations (consisting of video frames 2F1-2F7 and 1F1-1F7 respectively).

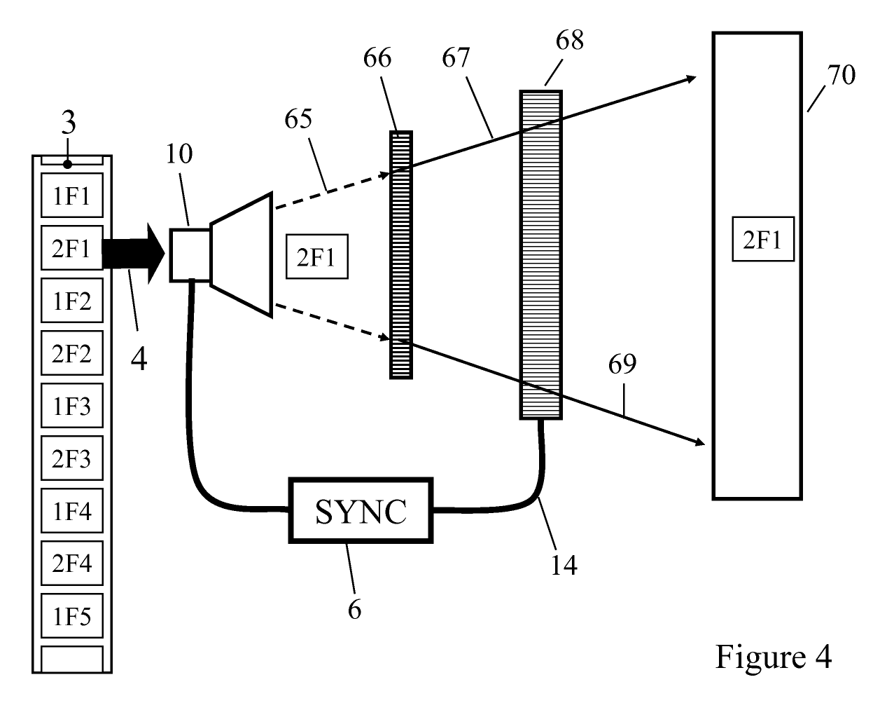

Referring to FIG. 4, a method and device to isolate and display a selective series of video frames from a compound video signal comprising of two or more sequentially intermeshed video streams is shown. The first frame of the second of two sequentially intermeshed video streams (2F1) within the compound video stream (3) has been isolated (4) and sent to the video display device (10). This isolated frame is displayed (indicated by the box containing 2F1) on the video monitor, and the image is comprised of randomly polarized light (65). This randomly polarized image passes through a horizontal linear polarizing filter (66), horizontally polarizing the transmitted image (67). The image then passes through an optically switchable linear polarizing filter (68) which is by default in a horizontally polarized state, which is maintained by an input (14) from a control unit (6) which is temporally synchronized to the output of the video display (10). Since the plane of polarization of both filters (66 and 68) match, the image of the individual frame passes through (69) the system and can be viewed (represented by the box containing 2F1 in item 70).

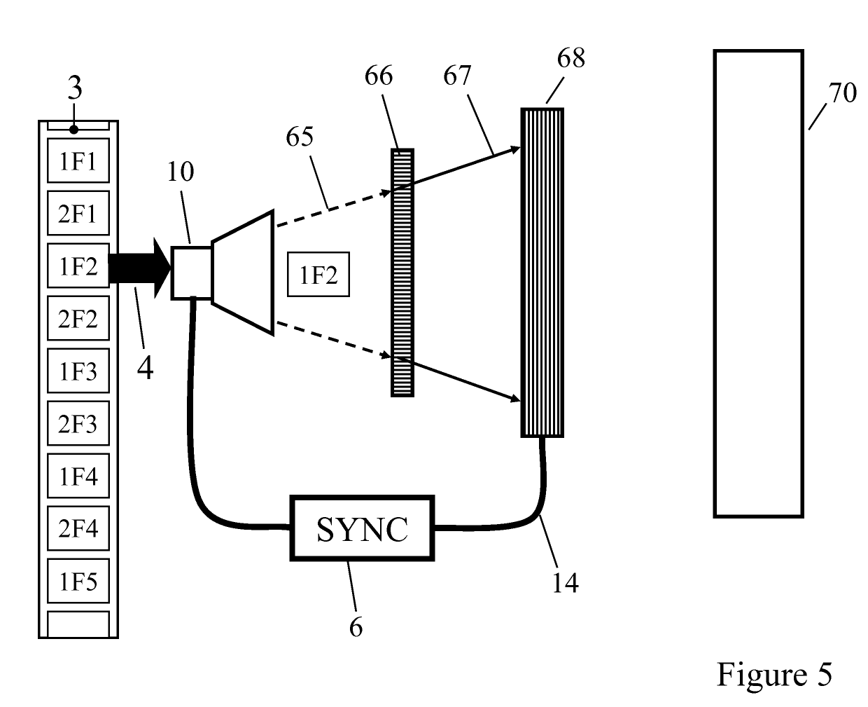

FIG. 5 illustrates how the method and device presented in FIG. 4 can selectively isolate and not display a selective series of video frames from within a compound video signal comprising of two or more sequentially intermeshed video streams. The second frame of the first of two sequentially intermeshed video streams (1F2) within the compound video stream (3) has been isolated (4) and sent to the video display device (10). As before, this isolated frame is displayed (indicated by the box containing 1F2) on the video monitor, and the image is comprised of randomly polarized light (65). As in FIG. 4 this randomly polarized image passes through a horizontal linear polarizing filter (66), horizontally polarizing the transmitted image (67). Since we want this frame to be selectively blocked, the optically switchable linear polarizing filter (68) is sent a signal from the control unit (6) which switches the polarizing filter into a vertical polarization mode. Since the plane of polarization of filters 66 and 68 now do not match (and are cross polarized), the image of the individual frame does not passes through the optically switchable linear polarized filter (69) and is not seen (represented by the blank box, 70).

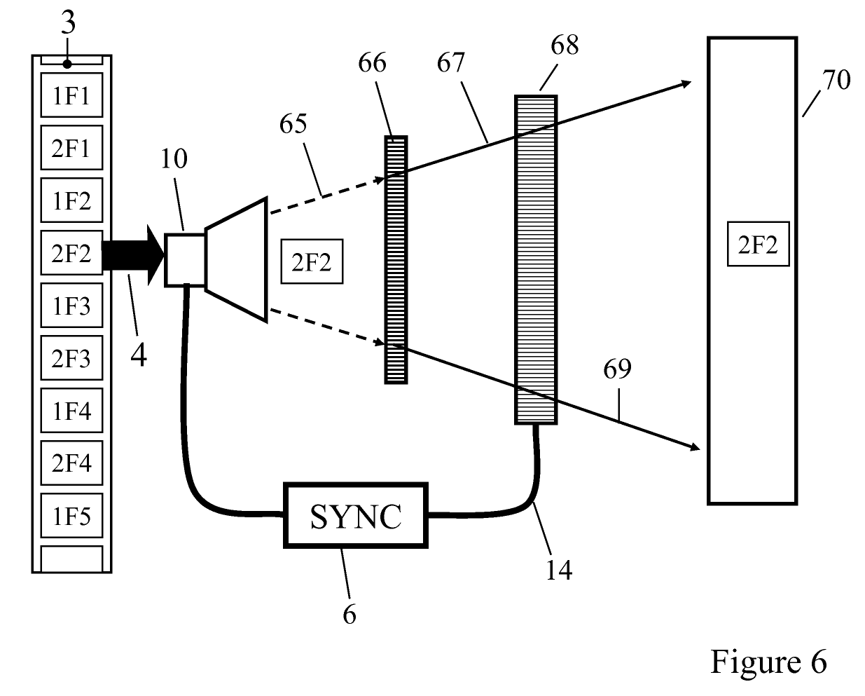

In FIG. 6, the second frame of the second of two sequentially intermeshed video streams (2F2) within the compound video stream (3) has been isolated (4) and sent to the video display device (10). This process is repeated, resulting in the extraction of the complete second embedded video stream.

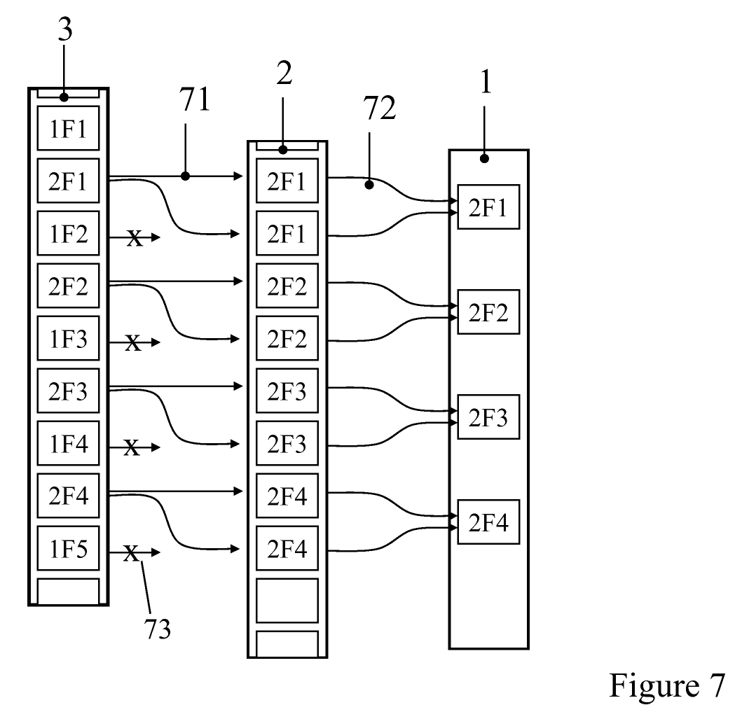

It is evident that the extraction of one of the more than one sequentially meshed streams of video data can also be selectively isolated prior to its presentation on the image monitor. FIG. 7 is a schematic representation of how a single video stream can be extracted and displayed after being isolated from a compound video signal containing more than one independent video stream. The original signal, having more than one sequentially meshed streams of video data is temporarily held in a video frame buffer (item 3 in FIG. 7). In the sample shown, video stream 2 has been selected for display. The first frame (represented by the box labelled 2F1 in item 3), and every subsequent frame in the second video series, is read out (represented by straight arrows labelled 71) into a temporary secondary frame buffer (item 2 in FIG. 7). To maintain the original recorded temporal integrity of the original video series, a duplicate frame of the selected video series is read into the next frame of the video frame buffer (represented by the curved arrows under item 71). This data is then sequentially passed on from the secondary frame buffer (indicated by curved arrows labelled 72) to be displayed at the original frame rate of the recorded video signal (as represented by item 1). Other video signals embedded in intermeshed video signals (as represented by video series 1F1-1F5) are not read out of the primary video frame buffer (as represented by crossed out short arrows like the one labelled 73).

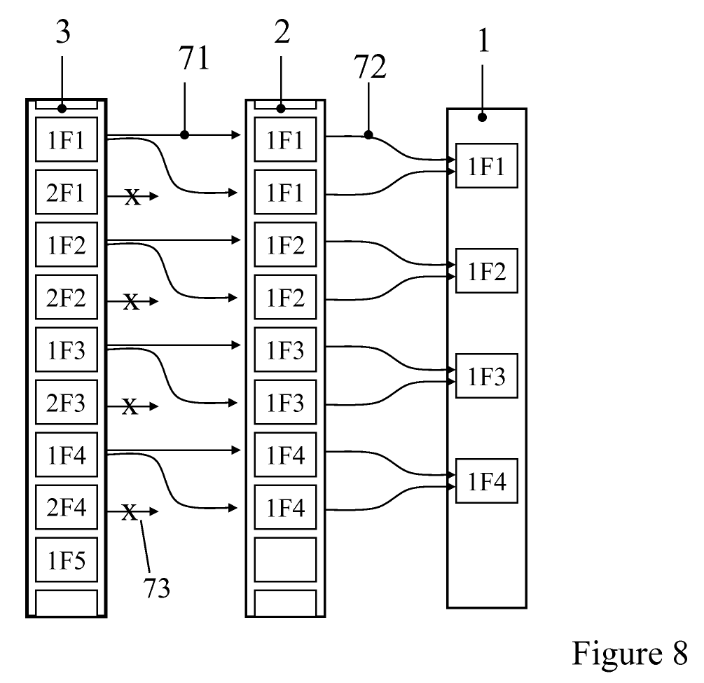

FIG. 8 is a schematic representation illustrating how, by simply advancing the initiation of the readout sequence by one frame, the video frame buffer readout method as outlined in FIG. 7 results in the isolation, readout and display of the second embedded video signals (represented by frames 1F1-1F4. The necessary hardware for caring about the select of isolation and display of one or more sequential intermeshed video signals could easily be embedded directly in the video monitors, in digital cable boxes, in digital video recorders or any other form of video recording or display device.

### DISCUSSION OF PRIOR ART

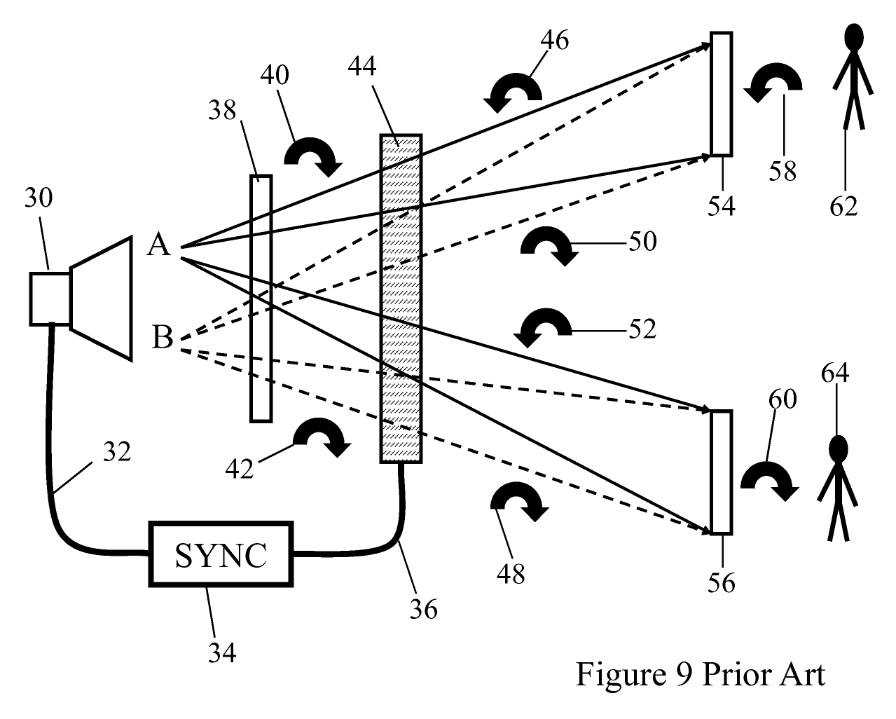

FIG. 9, Prior Art, is adapted from the patent of Berman (U.S. Pat. No. 4,879,603), illustrating a proposed system for the production of two independent video outputs from a common video monitor. In this system, frames from two independent video streams (represented by A and B) are alternately presented on a monochrome monitor (item 30). The output from video series A (represented by solid arrows) and video series B (represented by dashed arrows) initially are randomly polarized. After passing through a circular polarizer unit (item 38), the outputs of the A and B video series become right-hand circularly polarized (as represented by curved arrows item 40 and 42 respectively). A secondary switchable polarization unit (item 44) is connected (via item 36) to a synchronization unit (item 34) which is triggered through an input (item 32) every time an interlaced frame from video series A is shown on the video monitor (item 30). This secondary switchable polarizing unit (item 44) has the effect (when activated) of reversing the handedness of the circular polarization state of the signal passing through it (as represented by the changed curved arrows, item 46 and item 52).

When not activated, as in that case of during the presentation of the B video time series, the handedness of the circular polarization state is unaffected (as represented by the unchanged curved arrows, item 48 and item 50). By wearing glasses containing lenses made of left-handed circularly polarized filters (item 54), an observer (item 62) will only see the alternating frames from the A video time series (represented by curved arrow item 58). Alternately, a second observer (item 64) wearing glasses containing lenses made of right-handed circularly polarized filters (item 56) will only perceive the alternating presentation of the B video time series (represented by curved arrow item 60). Although elegant in design, this system and method of simultaneous presenting two different video sequences to independent observers is difficult and expensive to implement, therefore limiting its practicality.

Although similar in intended goals, the present invention and method differs in several significant ways from the prior art of Berman. Berman's method depends on having to alter the physical properties of light coming from a viewing screen before the independent intermeshed video streams can be separated. In contrast, the present method and mechanisms function by simply selecting a independent video stream for presentation and turning other video streams off. Berman's solution requires that the system must display the images in order to manipulate the physical properties of the light produced by the video display screen before the system can be used to isolate the individual or independent video streams. In contrast, the present method is based on selecting one or more video streams, and turning off the presentation of other video streams (even prior to display on the viewing screen).

In addition, the method and mechanism of Berman can only deal with a maximum of two intermeshed streams of video, one of which is modified (after being displayed on the video monitor) to having an optical characteristic of being left hand polarized, and the second of the intermeshed video streams being optically modified to having a right hand polarized characteristic. In contrast, the number of video streams which can be handled by the present method and mechanism is only limit by the refresh rate of the viewing screen. The faster the refresh rate, the more images we can display.

The prior art of Berman specialized optical mechanisms to modify the physical properties of the light given off by the display screen. In contrast, as the present method is based on turning some video streams on, and other streams off, the present method can be implemented to be displayed with all existing televisions and video monitors, and can even be utilized to view video images projected onto a wall (a process which would disrupt the polarization characteristics of a system or method such as Berman's). Although elegant in design, Berman's system and method of simultaneous presenting two different video sequences to independent observers is more mechanically complex and expensive to implement, and more limited in its capacity and practicality.

### Operation

According to the present invention there is provided a Method for Producing Differential Outputs from a Single Video Source. The system includes a compound video signal (item 3, FIG. 2) constructed by arranging alternate frames of two independent video series (items 1 and 2, FIG. 1), a video processing unit (item 6, FIG. 2) which transmits the alternating frames of the compound video signal to the video monitor (item 10, FIG. 2), while at the same time generating alternating sync signals which are used to time sync two optically switchable sets of viewing glasses (items 16 and 20, FIG. 2) to alternate series of frames in the compound signal.

Unlike the Prior Art method for producing concurrent differential output from a single video monitor, our proposed method is unique in that the process of generating the concurrent and independent video series requires no complex polarization mechanism or manipulation of the properties of the light coming from the images presented on the video monitor. The present system relies solely on time syncing the presentation of alternate frames in the compound video sequence with the transmissive state of a given set of optically switchable glasses. By simply alternating the sync signals to two pairs of such optically switchable glasses, a pair of observers will perceive independent video time series presented concurrently on a single TV or video monitor. With such a system, two individuals can simultaneously be engaged in a concurrent gaming environment with individual POVs utilizing the full display area of a single monitor.

It can be seen from the descriptions above, that such A Method for Producing Concurrent Differential Output from a Single Video Monitor can be used to, (1) allow two distinct video streams to be simultaneously presented on a common TV or video monitor. For example, using this technique (combined with independent audio signals matching each of the video inputs) would allow one individual to watch a live broadcast of a television program while at the same time another individual could be watching either a different live broadcast, or an earlier recorded video concurrently on the same TV or video monitor; (2) allow for “perceptual composting” or merging of two distinct video series (such as bit-mapped images and graphics) that are presented through independent and rapidly alternating series of frames which can then be selectively isolated through alternate syncing of the optically switchable glasses to either one of the two independent video series embedded in the compound signal; (3) allowed two individuals to engage in a concurrent gaming environment where each of the individuals POV is created utilising the whole display surface of a common video monitor. Combined with independent audio signals generated to match each of the unique POVs of the participants in the concurrent gaming environment, an uniquely immersive gaming experience could be produced for each player that is presently unavailable with existing gaming technology.

With the advent of “3-D ready” televisions, the frame rate of video presentations have been increased to 120 frames per second. As a result, the above proposed technique for the simultaneous presentation of independent video streams on a common TV or video monitor would allow for up to four independent video presentations to be presented concurrently. Alternately, two individuals could watch two independent 3-D video streams on the same TV or video monitor.

The present method could also be utilized to reduce the need for increased numbers of security display monitors as more video cameras are added to a security system. Two or more individuals could each watch independent security video streams from different cameras (or modes of camera operations such as daylight and thermal imaging modes) concurrently on the same set of TV or video monitors.

### Variations

The underlying principles of this Method for Producing Differential Outputs from a Single Video Source is not limited to; (1) any given method or mechanism for creating the independent video series that are fused through alternate presentation of frames into a compound video sequence (video sequences can be live, pre-recorded or the product of computer generated images); (2) any given method or mechanism for displaying the compound video sequence (video sequences can be presented directly on a video monitor or projected onto a screen since this new technique does not require the initial polarization of the images themselves for the separate video streams to be subsequently isolated) and (3) any given method or mechanism for transmitting the relevant sync signals within the system (components can be physically connected, operate through radio frequency communication such as Bluetooth, or be synced through infrared optical signals). It can also be seen that this Method for Producing Concurrent Differential Output from a Single Video Monitor could be implemented as a stand-alone system, or could be easily adapted as a secondary mode of operation utilising current 3-D visualisation technology (which already generate two alternating series of video frames) through simply implementing a different pattern of sync signals to the optically switchable lenses of current 3-D glasses. Furthermore, this system could be integrated into new digital TVs, TV boxes, digital video recorders and video gaming consoles. In addition, by generating “pre-fused” concurrent video signals (either live or prerecorded), the capacity of individually licensed broadcast stations to present programming on a single channel could be effectively doubled to quadrupled. Such concurrent signals could then be isolated by (1) utilizing individual LCD triggered glasses as described above, (2) using a switchable LCD screen over the entire surface of the TV or video monitor to isolate one of the more than one concurrent video streams, or (3) selectively blanking one or more of the independent video frame series that make up the concurrently presented video stream thereby selectively presenting only one of the more than one video streams at a given time.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

I claim:

1. A Method for Producing Differential Outputs from a Single Video source, comprising:
providing a single video source with two or more sequentially intermeshed video streams;
isolating through on and off temporal synchronization at least one of the two or more sequentially intermeshed video streams for viewing.

2. The method of claim 1, where there are more than two sequentially intermeshed video streams and on and off temporal synchronization is used to select any one of the more than two sequentially intermeshed video steams.

3. The method of claim 1, with the at least one of the two or more sequentially intermeshed video streams being temporally isolated by a decoder that has a viewing mode that allows one or more video streams to be viewed and a blackout mode that obscures one or more video streams, the decoder being synchronized to be in the viewing mode with the at least one video stream and in the blackout mode with all other of the two or more sequentially intermeshed video streams.

4. The method of claim 3, the decoder being built into a viewing screen.

5. The method of claim 4, the decoder being built into viewing glasses.

6. The method of claim 5, in a concurrent viewing mode with the two or more sequentially intermeshed video streams being displayed on the same viewing screen and the at least one of the two or more sequentially intermeshed video streams being isolated by viewing glasses that see different images, each of the viewing glasses having a viewing mode that allows a single video stream to be viewed and a blackout mode that obscures a video stream, the viewing glassed being synchronized to be in the viewing mode with the single video stream selected and in the blackout mode with all other of the two or more sequentially intermeshed video streams.
